(19) United States
(12) Patent Application Publication
(10) Pub. No.: US 2026/0115989 A1
(43) Pub. Date: Apr. 30, 2026

(54) A Variable Flow Recyclable Material Extrusion System and Method

(71) Applicant: Waste To Product Technologies Ltd., Ashdod (IL)

(72) Inventor: Avraham (Albert) BEN EZRI, Beer Sheva (IL)

(21) Appl. No.: 19/143,255

(22) PCT Filed: Nov. 14, 2023
(86) PCT No.: PCT/IL2023/051179

§ 371 Date: Jun. 25, 2025

Related U.S. Application Data
(60) Provisional application No. 63/479,063, filed on Jan. 9, 2023.

(51) Int. Cl. B29C 48/00; B29C 48/16; B29C 48/36; B29C 48/80; B29C 48/92; B29K 105/26

(52) U.S. Cl. CPC B29C 48/022; B29C 48/16; B29C 48/36; B29C 48/802; B29C 48/92; B29C 2948/92514; B29C 2948/92704; B29K 2105/26

(57) ABSTRACT

An extrusion system and method for manipulating and converting a recyclable multiphase material and producing a relatively uniform and homogenous output compounded product with predetermined composition of extruded materials.

### FIELD OF THE INVENTION

The present invention generally relates to extrusion systems and methods pertaining to recyclable materials, and more particularly, extrusion systems and methods used to manipulate and convert a recyclable multiphase material.

### BACKGROUND OF THE INVENTION

In traditional recycling processes, following initial sorting once waste materials are collected, the materials to be recycled (and primarily home waste) may be divided to typical groups of waste materials such as groups of plastic, glass and metal (in addition to the group of typically other, non-recyclable materials). Typically, such sorted groups are not uniform nor homogenous: the plastic group may comprise of a blend of many types of plastic having various different traits such as melting temperatures, hardness and containing different coloring materials. Similarly, the glass group may comprise different types of glass and the metal group, various types of alloys having very different traits. Thereby each such group of materials may be characterized as a multiphase compounded material wherein there is more than one distinct compound in the material and the compounds form distinct regions in the substance with different properties.

Piston extruders for processing recyclable waste, typically comprising plastic and non-plastic particles, are known in the art. Nevertheless, current general extrusion systems and methods are typically limited to extruding of uniformly mixed highly viscous materials such as molten plastic or fluid rubbers. Such extruders would not suit the processing of recyclable material which is characterized by being heterogenous and comprising of various materials.

Typically, shredded, crushed, dried or otherwise processed waste is fed into the extruder, and the particles flow within the barrel of a screw extruder under high pressure and temperature. The extrusion process is directed at recycling waste materials and obtaining a uniform and substantially homogenous product material which can be appropriated for various uses.

Current extrusion systems and methods support the obtainment of relatively low rate of uniformity and homogeneity output material, thereby limiting the rate of re-appropriation of the recycled materials. Improving the rate of uniformity and homogeneity of output material would diversify and enlarge the scope of appropriations to which the recycled materials can be used and improve the commercial viability and sustainability of the recycling process.

More so, extrusion systems and methods are highly dependent upon the composition of the input waste material. Typically, such methods and systems do not change the ratio of the compounds in the output material. Nevertheless, such ratio would be determinant as to the final use of the material and its shape. It being appreciated that the ability to shape the output product mostly a of a paste-like substance-to predetermined shapes, would highly depend upon the characteristics of the output material and would affect the ability to form certain three-dimensional shapes. Current methods and systems'output would typically be highly dependent upon the type of inputted materials and thereby affect the flexibility or versatility (or lack thereof) of outputted materials.

Some systems and methods known in the art are directed to such ends by exploiting the different viscosity and flow characteristics of the compounded material while flowing through an extruder. One such method (such as U.S. Pat. No. 8,721,299) suggests a piston member that includes a piston rod provided with a piston serves for reciprocating inside a cylinder barrel, the piston dividing the cylinder barrel chamber into a proximal cylinder barrel chamber having a proximal capped end opposite the piston and a distal cylinder barrel chamber having a distal cylinder barrel end opposite the piston, wherein the movement of the pistons inside the cylinder barrels is controlled in relation to each other to transport apportioned batches of coal powder to a high pressure reactor.

Another method (such as U.S. Pat. No. 4,695,165) suggests the amalgamation of certain compounds in the material by use of a rotor-stator element installed within the extruder barrel thereby increasing pressure on the overall compounded material and thus contribute to the uniformity of the output material. Such system and method and others involve a complex and expensive apparatus while providing a low rate of control of the output material's characteristic (i.e. percent of each designated compound in output material). In this method with the non-uniformity of the waste it can enlarge the voids and fractures in the end product

Thus, there is a need in the art to provide an extrusion system and method which can handle recyclable multiphase materials with certain flexibilities to affect the processed material (such as the constitution and compound of the inputted material, the chemical interactions between the material components, etc.) while producing a relatively uniform and homogenous output compounded product with predetermined composition of materials while presenting a cost-effective solution thereto.

### SUMMARY OF THE INVENTION

The present invention discloses a variable flow, cost effective, efficient and smart extrusion system and method which can handle recyclable multiphase materials (that may comprise of polymeric and non-polymeric substances, as well as other materials) while producing a relatively uniform and homogenous output compounded product with a controllable composition of materials. The system and method according to the invention subjects the processed compounded waste to a range of pressures and temperatures within the chamber of an extruder in a manner which controls the flow therein and affects certain of the waste components' temperature and pressure, thereby outputting a prescribed compounded material (such as whereby during the flow of the recyclable material along the containing volume, the polymeric substances are designated to melt and encapsulate the non-polymeric substances).

The following embodiments and aspects thereof are described and illustrated in conjunction with systems, devices and methods which are meant to be exemplary and illustrative and not limiting in scope. In various embodiments, one or more of the above-described problems have been reduced or eliminated, while other embodiments are directed to other advantages or improvements.

According to a first aspect of the invention, there is provided a variable flow recyclable material extrusion system, comprising at least one containing volume of substantially a barrel shape having an outlet and an inlet and designated to contain a recyclable material that comprises various substances having at least two thermodynamic phases and capable of a multiphase flow, at least one sliding element configured to move within said containing volume and further configured to increase the pressure of the recyclable material and create a movement thereof toward the outlet of said containing volume, at least one physical structure located along the inner perimeter of the containing volume, and a power source. Wherein the recyclable material is designated to flow within the containing volume along a flow line in accordance with the multiphase flow of the substances, wherein the at least one physical structure is designated to affect the multiphase flow of a substance/s by creating a movement thereof at different thermodynamic phases, and wherein said movement is designated to obtain predetermined physical properties of the extruded recyclable materials.

According to some embodiments of the invention, at least two containing volumes are configured to contain at least two sliding elements further configured to move within said containing volumes.

According to some embodiments of the invention, at least one heating element configured to affect the conversation of the recyclable material.

According to some embodiments of the invention, the conversion to a composite material is a result of various interactions between the pressure/s and heat subjected to the recyclable material while flowing along the containing volume and being affected by the physical structure/s and/or heating element/s.

According to some embodiments of the invention, the heating element is located outside the containing volume and designated to heat the recyclable material without direct contact with it.

According to some embodiments of the invention, the heating element is located inside the containing volume and designated to heat the recyclable material using a direct contact with it.

According to some embodiments of the invention, the at least one heating element is located at different angles/orientations relative to the flow line in order to have a preferable effect on the different thermodynamic phases and hence, the conversion of the recyclable material to a composite material.

According to some embodiments of the invention, at least two sliding elements are configured to move within one containing volume and further configured create a spiral movement designated to convert the recyclable material to a composite material having different physical properties in comparison to the recyclable material fed into the containing volume.

According to some embodiments of the invention, the sliding element comprises designated notch/es configured to accommodate the heating element/s and thus enabling the sliding element to advance further within the containing volume towards the outlet.

According to some embodiments of the invention, the sliding element comprises a designated inclined front surface configured to accommodate correspondingly inclined heating element/s and thus enabling the sliding element to advance further within the containing volume towards the outlet.

According to some embodiments of the invention, the outlet is configured to be fitted with a cover having at least one aperture.

According to some embodiments of the invention, the cover is configured to accommodate at least one heating element/s and wherein the recyclable material is designated to flow through or along said heating element/s and out through the at least one aperture.

According to some embodiments of the invention, at least one recess embedded in the inner perimeter of the containing volume and further comprising at least one physical structure configured to affect the multiphase flow of a substance/s by creating a movement thereof at different thermodynamic phases.

According to some embodiments of the invention, at least one recess is configured to be spirally stretched along the inner perimeter of the containing volume/configured to be connected to another recess at an angle/connected to at least one other recess in an angle of 90 degrees/further comprises at least one heating element.

According to some embodiments of the invention, the at least one physical structure is configured to create turbulences designated to have a greater effect on the substance/s having a slower thermodynamic phase.

According to some embodiments of the invention, the sliding element is a piston shaped element parallel to the containing volume's axis.

According to some embodiments of the invention, the composite material comprises various substances such as organic/nonorganic substances, aggregates, cellulose, polymers, etc.

According to some embodiments of the invention, the recyclable material is a waste material processed to particles.

According to some embodiments of the invention, the particles having a diameter smaller than 30 mm /the particles having a diameter smaller than 8 mm/the particles having a diameter smaller than 5 mm/

According to some embodiments of the invention, the composite material is configured to undergo an injection molding.

According to some embodiments of the invention, the physical structure is a protrusion configured to delay the flow of at least one substance/the physical structure is a protrusion configured to expedite the flow of at least one substance/the physical structure is at least one fin/the physical structure is at least one bulge/protrusion/the physical structure is at least one aperture/slit.

According to some embodiments of the invention, the at least one aperture/slit is designated to delay the flow of at least one substance by increasing the probability that a substance/s having a slower thermodynamic phase will be accumulated within said aperture/slits.

According to some embodiments of the invention, the at least one physical structure is designated to delay the flow of at least one substance by increasing the probability that a substance/s having a slower thermodynamic phase will have a greater probability to be slowed down by the physical structure.

According to some embodiments of the invention, at least two physical structures are designated to be located on a same perpendicular cross-section plane along the containing volume.

According to some embodiments of the invention, at least two pairs of physical structures are designated to be located on different perpendicular cross-section planes along the containing volume.

According to some embodiments of the invention, the recyclable material comprises polymeric and non-polymeric substances, wherein during the flow of the recyclable material along the containing volume, the polymeric substance/s is designated to melt and encapsulate the non-polymeric substance/s.

According to a second aspect of the invention, there is provided a method for using a variable flow recyclable material extrusion system, comprising the steps of feeding a recyclable material to a containing volume of substantially a barrel shape having an outlet and an inlet, translating the recyclable material using at least one sliding element powered by a power source and configured to move within the containing volume toward its outlet. Wherein the recyclable material comprises various substances having at least two thermodynamic phases and capable of a multiphase flow, wherein the recyclable material is designated to flow within the containing volume along a flow line in accordance with the multiphase flow of the substances, wherein at least one physical structure is designated to be located on the inner perimeter of the containing volume and affect the multiphase flow of a substance/s by creating a movement thereof at different thermodynamic phases, and wherein said movement is designated to obtain predetermined physical properties of the extruded recyclable materials.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention.

In the Figures:

FIG. 1 constitutes a cross-sectional view of a recyclable material extrusion system, according to some embodiments of the invention.

FIG. 2 constitutes a cross-sectional view of a recyclable material extrusion system, according to some embodiments of the invention.

FIG. 3 constitutes a cross-sectional view of a recyclable material extrusion system, according to some embodiments of the invention.

FIG. 4 constitutes a cross-sectional view of a recyclable material extrusion system, according to some embodiments of the invention.

FIG. 5 constitutes a schematic illustration of flow patterns within a recyclable material extrusion system, according to some embodiments of the invention.

FIG. 6 constitutes a cross-sectional view of a recyclable material extrusion system, according to some embodiments of the invention.

FIG. 7A-7C constitutes a cross-sectional view of a recyclable material extrusion system, according to some embodiments of the invention.

FIG. 8A-8D constitutes a cross-sectional view of a recyclable material extrusion system, according to some embodiments of the invention.

FIG. 9 constitutes a cross-sectional view of a recyclable material extrusion system, according to some embodiments of the invention.

### DETAILED DESCRIPTION OF SOME EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “controlling” “processing,” “computing,” “calculating,” “determining,” “establishing”, “analyzing”, “checking”, “setting”, “receiving”, or the like, may refer to operation(s) and/or process(es) of a controller, a mechanical controller, a computer, a computing platform, a computing system, a cloud computing system or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes, a translation of algorithm steps or orders to a physical medium by way of mechanical or otherwise physical means.

Unless explicitly stated, the method embodiments described herein are not constrained to a particular order or sequence. Additionally, some of the described method embodiments or elements thereof can occur or be performed simultaneously, at the same point in time, or concurrently. The method embodiments may be materialized by the system described herein or otherwise.

The present invention discloses a designated variable flow recyclable material extruder system comprising unique modifications. A person skilled in the art would appreciate that such modifications may be incorporated in the original design and production of such a system and/or retrofitted on available extruding systems.

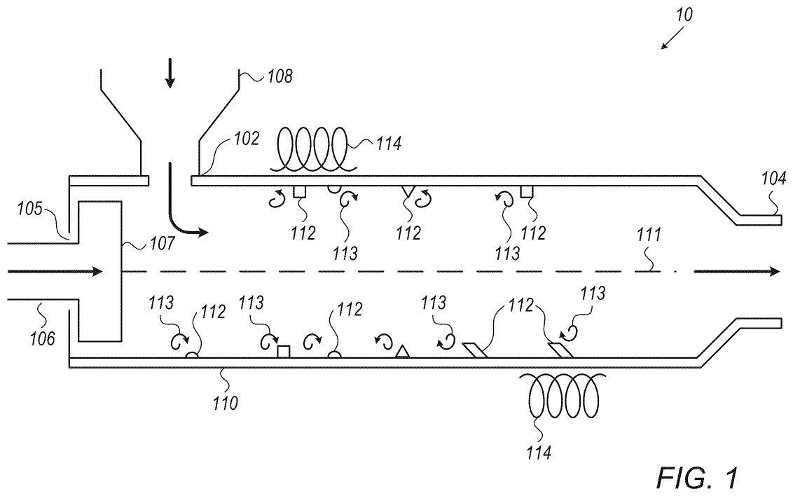

Reference is now made to FIG. 1 which depicts a variable flow recyclable material extrusion system, according to some embodiments of the invention. As shown, an extrusion system 10 would essentially comprise of an annular, substantially cylindrical containing volume 110 substantially enclosing a volume. According to some embodiments, containing volume 110 may be configured with at least two apertures, for example, inlet aperture 108 may be configured as a hopper designated to supply materials to be processed and outlet aperture 104 may be configured as an outlet designated to provide an output to said processed materials. According to some embodiments, the recyclable material is designated to be processed into other materials having different properties.

According to some embodiments, container 110 may be configured with an additional aperture 105 through which a sliding element 106 having a positive displacement means 107 may be installed. For example, sliding element 106 may be a piston shaped shaft designated to compress the material within containing volume 100. According to some embodiments, any other positive displacement means may produce the same or similar effect according to the present invention.

According to some embodiments, a typical method of extrusion operation would entail the inputting of recyclable materials into hopper 108 which is to be coupled with aperture 102. According to some embodiments, compressing means may be installed above of within hopper 108 (not shown) and configured force materials into the containing volume 110 and through aperture 102 to be further advanced by the sliding element 106 towards containing volume's outlet aperture 104 while being processed. According to some embodiments, the variable flow extrusion system 10 is designated to apply certain pressures to the recyclable materials which, in turn, are designated to progress along progression line 111.

According to some embodiments, extrusion system 10 may be configured to enable the conversation of recyclable multiphase materials inserted through inlet aperture 102 via hopper 108. Such Recyclable multiphase materials may typically originate from waste components containing organic materials, aggregates, cellulose, plastic, polymers, etc., while the waste is shredded to comprise of polymeric and non-polymeric substances. According to some embodiments, said shredding would typically be conducted to 30 mm sized shreds and smaller. It being notes that a person skilled in the art would appreciate that various compounded recyclable and other types of materials may also be inputted and processed through variable flow extrusion system 10.

According to some embodiments, while being conveyed along the containing volume's axis 111 and subjected to pressure/s and heat provided by heating element/s 114 and the sliding element 106 (which is coupled with a power source), the recyclable material is converted to a designated composite material, wherein the converted composite material is extruded at a multiphase flow and has different physical properties in comparison to the recyclable material initially fed into the containing volume 110. According to some embodiments, the composite material is configured to undergo an injection molding further down the recycling process. According to some embodiments, heating element/s 114 may be in the form of a heating collar engulfing the containing volume 110.

According to some embodiments, the one or more heating elements 114 may be positioned along the containing volume 110 (either internally within positive progression means 107 or on the internal/external perimeter of containing volume 110) is designated to affect the temperature of the material being processed within the containing volume 110. It would be appreciated by a person skilled in the art that heating the processed material at different points may contribute to the delaying or expediting of the flow of the processed material as well as affect the encapsulation of polymeric and non-polymeric phases of the material into a compounded material.

According to some embodiments of the invention, the conversion to a designated composite material is a result of various interactions (thermodynamical, chemical, mechanical, etc.) between the pressure/s and heat subjected to the recyclable material comprised of components having different thermodynamical characteristics while flowing along the designated flow path 111 in the containing volume 110 and being affected by physical structure/s 112 located on and along containing volume 110 (as broadly disclosed below).

According to some embodiments, the processed compounded waste is subjected to a range of varying pressures and temperatures within containing volume 110 in a manner which enables the control of the flow therein and affects certain of the waste components'temperature and pressure. According to some embodiments, outputting a prescribed compounded material such as during the flow of the recyclable material along the containing volume 110, may result in polymeric substances to melting and encapsulate the non-polymeric substances.

According to some embodiments, at least one physical structure 112 is configured to be located along the inner perimeter of the containing volume 110 and designated to affect the multiphase flow of some of the substance/s comprising the recyclable material. For example, at least one physical structure 112 may be located on the inner perimeter of the containing volume 110 and configured to create turbulences/vortices 113 designated to have a greater effect on the substance/s having a thermodynamic phase of lower dynamic characteristics. It is being appreciated by a person of the art that said physical structure/s 112 may be of varied shapes (such as a fin, bulge or any protrusion, aperture, slit shape, etc.).

According to some embodiments, said physical structure/s 112 may be configured to delay or otherwise expedite the flow of at least one substance of the multiphase material. It being appreciated that such expediting or delaying may be based on the probability that a substance/s having a slower thermodynamic phase will be accumulated within said aperture/slits or otherwise detained by said physical structure due to the creation of vortices 113 the size and impact of which will depend on the overall various parameters such as waste attributes, particle size, particle size disbursement, speed of extrusion, and size, shape and location of the physical structure/s 112.

According to some embodiments, having at least two pairs of physical structures 112 that are designated to be located on different perpendicular cross-section planes along containing volume 110 may also achieve different desired results of detaining or expediting one or few of the types of compounds in the multiphase recyclable material.

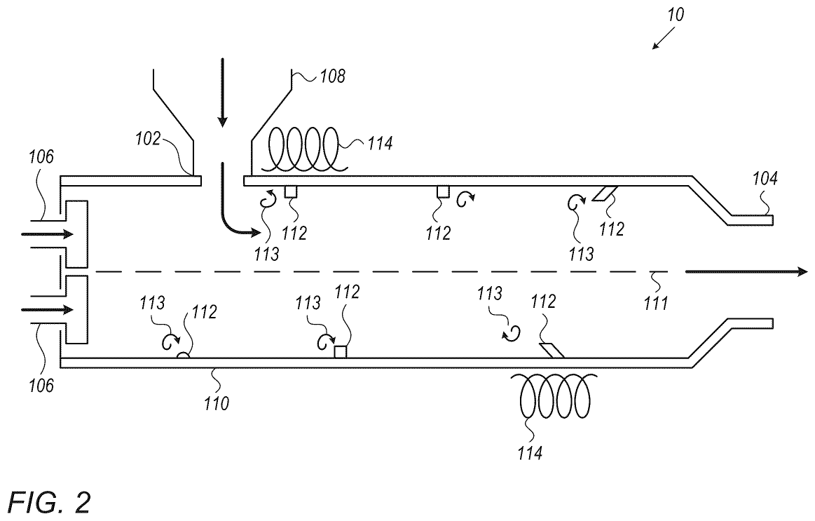

Reference is now made to FIG. 2 which depicts a variable flow recyclable material extrusion system, according to some embodiments of the invention. As shown, an extrusion system 10 would essentially comprise of an annular, substantially cylindrical containing volume 110 substantially enclosing a volume. According to some embodiments and as previously disclosed, containing volume 110 may be configured with at least two apertures, for example, inlet aperture 102 may be configured as an inlet designated to supply materials to be processed and outlet aperture 104 may be configured as an outlet designated to provide an output to said processed materials. According to some embodiments, the material are recyclable materials designated to be processed into other materials having different properties.

According to some embodiments, the variable flow recyclable material extrusion system 10 may comprise at least two sliding elements 106 designated to compress the recyclable material. Said multiple sliding elements 106 may be in the shape of pistons configured to apply different pressures values upon the recyclable material enclosed within the containing volume 10. According to some embodiments, said pistons may enable a complicated and delicate control of the conversion process described above.

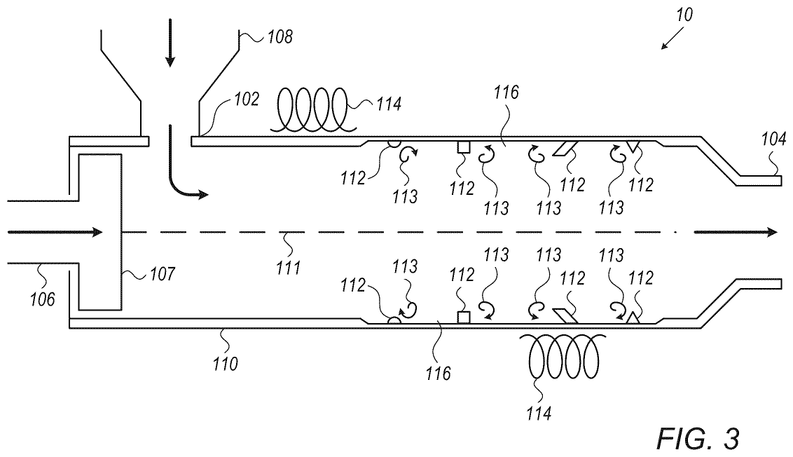

Reference is now made to FIG. 3 which depicts a variable flow recyclable material extrusion system, according to some embodiments of the invention. As shown, an extrusion system 10 would essentially comprise of an annular, substantially cylindrical containing volume 110 substantially enclosing. According to some embodiments, containing volume 110 may be configured with at least two apertures, for example, inlet aperture 102 may be configured as an inlet designated to supply materials to be processed and outlet aperture 104 may be configured as an outlet designated to provide an output to said processed materials. According to some embodiments, the material are recyclable materials designated to be processed into other materials having different properties.

According to some embodiments, the at least one physical structure 112 is designated to be located within a recess 116 embedded within the inner perimeter of containing volume 110. According to some embodiments, when sliding element 106 is compressing the recyclable material and advances along flow line 111, the recyclable material located in close proximity to the inner perimeter of containing volume 110 enters recess 116 and subjected to various interactions with the physical structure/s 112 as broadly disclosed above.

According to some embodiments, said configuration enables the compressing end part of sliding element 106 (positive displacement means 107) to fully occupy the width of containing volume 110. For example, sliding part 106 may be in the shape of a piston and the piston crown/head is configured to tightly move along flow line 111 while compressing and pushing the recyclable material while leaving little or no space between the inner perimeter of the containing volume 110 and the piston. According to some embodiments, said configuration may improve the efficiency of the extrusion system 10 since the sliding element may compress and push more recyclable material without leaving a gap due to the protruding physical structure/s 112. Another benefit may arise from the fact that the recyclable material may flow in different pressure/temperature/velocity along recess 116 while being transformed a material having different characteristics as broadly disclosed above.

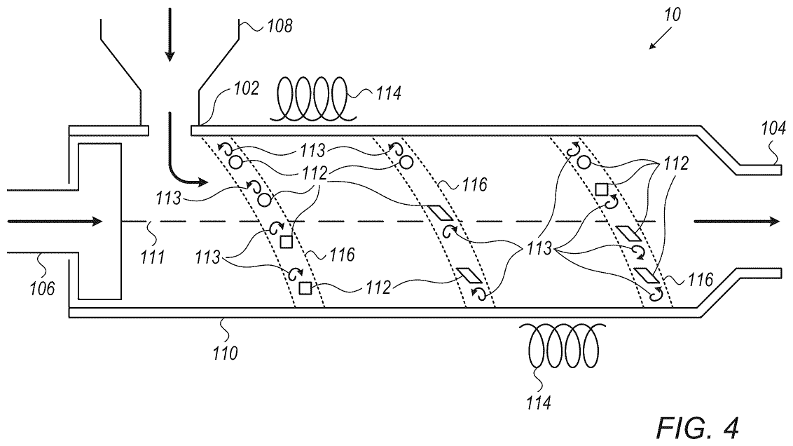

Reference is now made to FIG. 4 which depicts a variable flow recyclable material extrusion system, according to some embodiments of the invention. As shown, recess 116 may be in the form of a spiral canal embedded in the inner perimeter of the containing volume 110 and curling along its length.

According to some embodiments, said configuration enables the compressing end part of sliding element 106 to be fully stretched across the width of the containing volume 110 while advancing toward outlet 104. For example, sliding part 106 may be in the shape of a piston and the piston crown/head is configured to tightly move along flow line 111 while compressing and pushing the recyclable material while leaving little or no space between the inner perimeter of the containing volume 110 and the piston. According to some embodiments, said configuration may improve the efficiency of the extrusion system 110 since the sliding element may compress and push more recyclable material without leaving a gap due to the protruding physical structure/s 112.

According to some embodiments, the configuration of recess 116 in the form of a spiral canal curling around containing volume 110, provides a long canal designated for converting and affecting the recyclable material through a long conversion route. The recyclable material may flow within a long recess 116 or multiple recesses 116 (not shown) while being affected by multiple physical structure/s 112 and heating elements 114 until being extracted through the outlet 104.

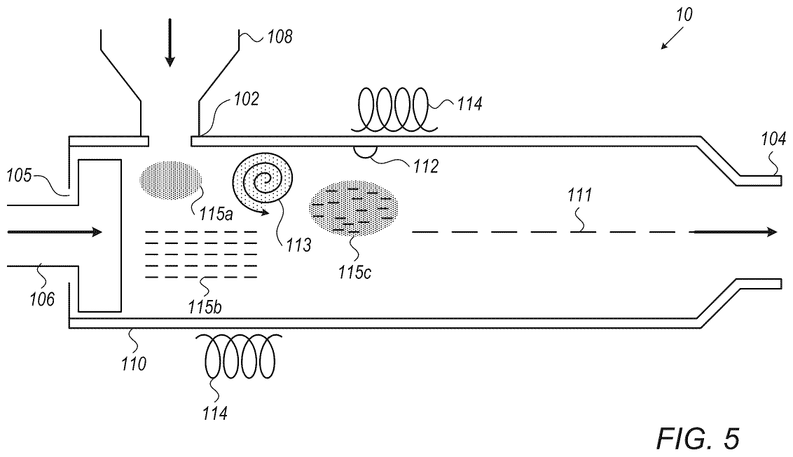

Reference is now made to FIG. 5 which depicts flow patterns within a variable flow recyclable material extrusion system, according to some embodiments of the invention. As shown, at least one physical structure/s 112 is configured to be located along the inner perimeter of the containing volume 10 and designated to have a variable effect on the various multiphase flows of particles 115a and/or 115b comprising (among others) the substance/s comprising the recyclable material. For example, particles 115a and/or 115b may be combined to create a multiphase flow of particles 115c that comprises a combination thereof. According to some embodiments, the newly formed substance that comprises particles 115c has different physical/chemical characteristics comparing to the substance/s the comprised particles 115a & 115b.

According to some embodiments, the at least one physical structure 112 may be located on the inner perimeter of the containing volume 10 and be configured to create turbulences/vortices 113 designated to have a variable effect on substance/s having different thermodynamic phases characteristics and comprising the recyclable material.

For example, the recyclable material flowing along flow path 111 may comprise of various sizes of particles (for example, larger particles exemplified by dash (such as 115b) and smaller particles exemplified by dots (such as 115a) thereby exemplifying at least two phases of the recyclable material. Applicant emphasized that any other difference between the particle is also possible, for example, mass, friction characteristics, magnetism, molecular affinity, etc.) designated to progress along flow line 111 due to instigation by sliding element 106.

According to some embodiments, said recyclable material flow may be disrupted by physical structure/s 112 that may be, for example, in a bulge shape which may cause the flow path's vector of any particle group to flow differently, thereby causing downstream turbulence/vortex 113 after flow passage over said physical structure/s 112.

According to some embodiments and by nature of flow characteristics and innate viscosity characteristics of the coagulated material, the smaller particles of lower mass and resistance, which are typically the non-polymerics, accumulate in turbulence/vortex 113 formed closer to the center of containing volume 110, while larger parts of the material, which are typically the polymerics, concentrate in the un-perturbated volume closer to perimeters of containing volume 110. Thereby, the material flow arrives downstream to outlet aperture 104 wherein the outer layer of vector flow contains substantially polymeric materials which surround and encapsulate the non-polymeric smaller particles residing in the inner vector flow closer to the center of containing volume 110. According to some embodiments of the invention, the larger particles of the waste material inputted to hopper 108 may have a diameter smaller than 5 mm, 8 mm or 30 mm.

According to some embodiments, single or multiple physical structure/s 112 along with single or multiple heating element/s 114 may create single or multiple turbulence/s/vortex/s 113 that, may result in complex interactions and/or chemical or physical reactions within containing volume 110 and, in turn, may have an effect on the recyclable material's conversion.

According to some embodiments, heating element/s 114 may be in multiple forms and be configured to be installed in the perimeter of containing volume 110. For example, heating element/s 114 may have a spiral shape and may be installed in a particular angle relative to flow line 11 in order to create a requested flow and movement of the recyclable material. In another example, multiple heating element/s 114 are configured to be in arranged in a particular order within the perimeter of containing volume 110 or in any other position along the containing volume 110 in order to create a requested flow and movement of the recyclable material.

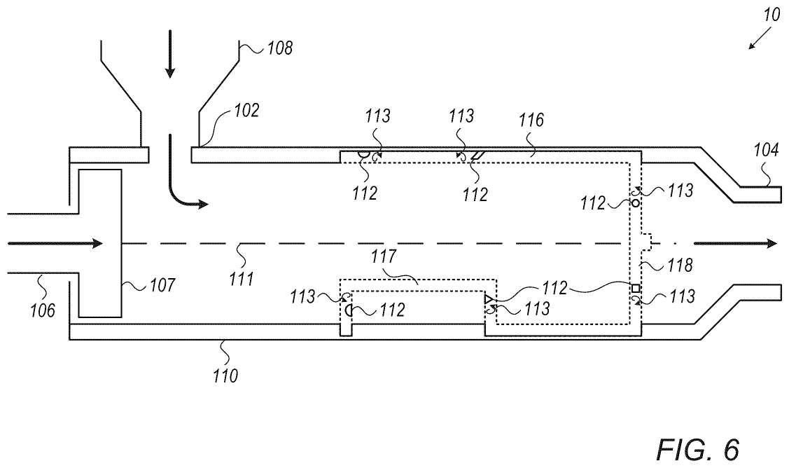

Reference is now made to FIG. 6 which depicts a variable flow recyclable material extrusion system, according to some embodiments of the invention. As shown, recess/es (such as recess 116 previously disclosed) may spread across the perimeter of the containing volume 110 in an ununified form, for example recess 117 may be in the form of a U shape canal. In another example, recess 118 may also spread across the containing volume 110 perpendicular to the flow line 111. In another example, recesses 116 & 117 may be joined together with recess 118 in order to form an elongated canal allowing the recyclable material to flow in a designated way and be subjected to designated and various forces/constrains while being transformed either thermodynamically or chemically to an altered composite material.

According to some embodiments, and as previously disclosed, recesses 116/117 may be stretched across the perimeter of containing volume 110 and generally along the flow line 111 and configured to be connected in a sharp angle, (such as 90 degrees) to recess 118 which spreads across the perimeter of containing volume 110 while being perpendicular to flow line 111, this angular connection may create a sharp shift in flow and may have a profound thermodynamic influence on the recyclable material being converted to a composite material.

According to some embodiments some sections of the various recesses 116/117/118 depicted in FIG. 6 may be straight and some sections me be designed in accordance with variable mathematical functions designated to cause desirable thermodynamic transformations of the recyclable material flowing through containing volume 110.

According to some embodiments and as previously disclosed, while being conveyed along the containing volume's 110 axis and potentially subjected to pressure/s and heat provided by the heating element/s 114 and the sliding element 106 coupled with the power source, the recyclable material is converted to a designated composite material, and wherein the converted composite material is extruded at a multiphase flow and has different physical properties in comparison to the recyclable material initially fed into the containing volume 110.

According to some embodiments of the invention, the conversion to a designated composite material is a result of various interactions (thermodynamical, chemical, mechanical, etc.) between the pressure/s and heat subjected to the recyclable material comprised of components having different thermodynamical characteristics while flowing along the designated flow path 111 and being affected by the physical structure/s 112 located on and along the inner perimeter of containing volume 110.

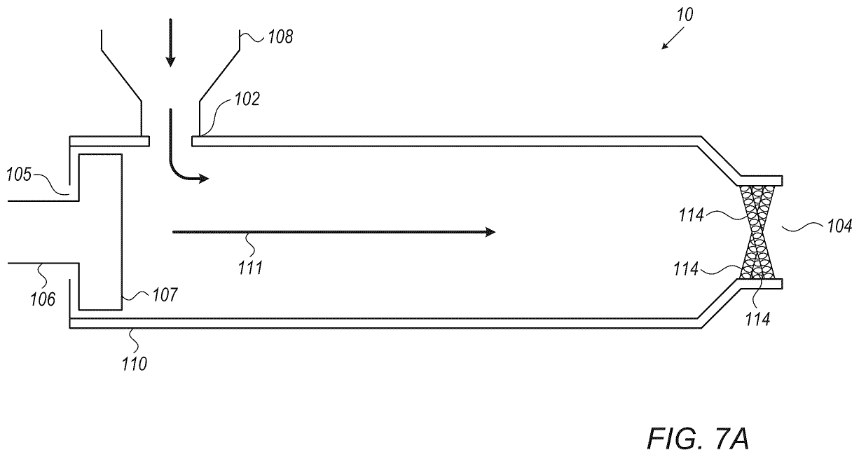

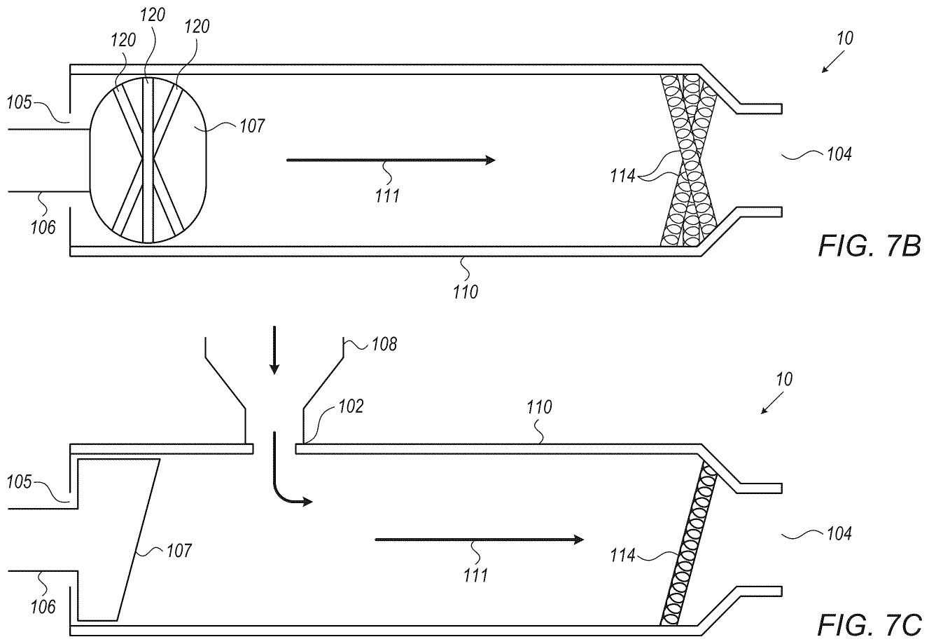

Reference is now made to FIGS. 7A & 7B which depicts a variable flow recyclable material extrusion system 10, according to some embodiments of the invention. As shown, one or more heating elements 114 may be positioned in close proximity to the outlet aperture 104 positioned at the end of containing volume 110, wherein said heating element/s 114 is designated to affect the temperature of the material being processed within the containing volume 110. It would be appreciated by a person skilled in the art that heating the processed material at different points may contribute to the delaying or expediting of the flow of the processed material as well as affect the encapsulation of polymeric and non-polymeric phases of the material into a compounded material.

According to some embodiments and as previously disclosed, containing volume 110 may be configured with an additional aperture 105 through which a sliding element 106 having a positive displacement means 107 may be installed. For example, sliding element 106 may be a piston shaped shaft designated to compress the material within containing volume 100. According to some embodiments, any other positive displacement means may produce the same or similar effect according to the present invention.

According to some embodiments, a typical method of extrusion operation would entail the inputting of recyclable materials into hopper 108 which is to be coupled with aperture 102. According to some embodiments, the variable flow extrusion system 10 is designated to apply certain pressures to the recyclable materials which, in turn, are designated to progress along progression line 111.

According to some embodiments, said heating element/s 114 is designated to be placed in different angles across/along the area in close proximity to outlet aperture 104 wherein said distribution of heating element/s 114 may affect the properties of the recyclable material being converted to a composite material in a preferred way.

According to some embodiments, displacement means 107 may be configured with at least one designated notch/es 120 which matches in dimensions to the heating element/s 114 as can be seen in FIG. 7B. The configuration thereof may enable displacement means 107 to advance along flow line 111 while pushing the recyclable material towards outlet 104 until heating element/s 114 are partly of fully surrounded by designated notch/es 120. According to some embodiments, said configuration may allow displacement means 107 to advance along container 110 to a greater extent since heating element/s 114 does not block its advancement and more recyclable material may be displaced toward outlet 104.

FIG. 7C depicts a variable flow recyclable material extrusion system 10, according to some embodiments of the invention. As shown, one or more heating element/s 114 may be positioned in close proximity to the outlet aperture 104 positioned at the end of containing volume 110, wherein said heating element/s 114 is designated to be placed at different angles across/along the area in close proximity to outlet aperture 104, wherein said distribution of heating element/s 114 may affect the properties of the recyclable material in a preferred way.

According to some embodiments, displacement means 107 may be configured to be in the shape that corresponds to the dimensions of heating element/s 114, for example, displacement means 107 may be inclined in order to fit a corresponding angle of the heating element 114 such that displacement means 107 will be able to displace a maximum amount of the recyclable material along flow line 111 until reaching outlet 104. It is noted that displacement means 107 may be in any shape or form that corresponds to the dimensions of heating element/s 114 in order to reach maximum displacement capabilities of the recyclable material within containing volume 110.

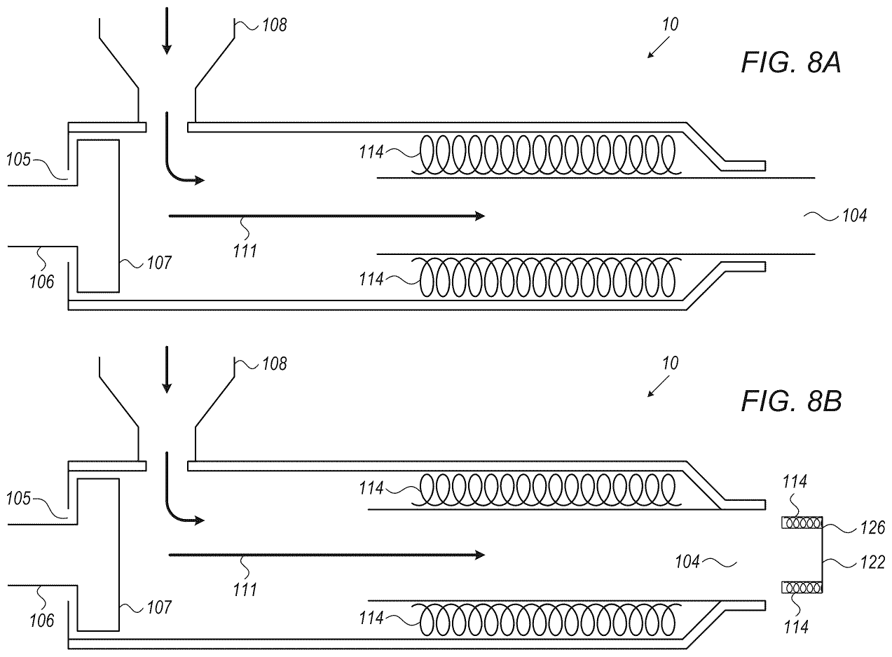

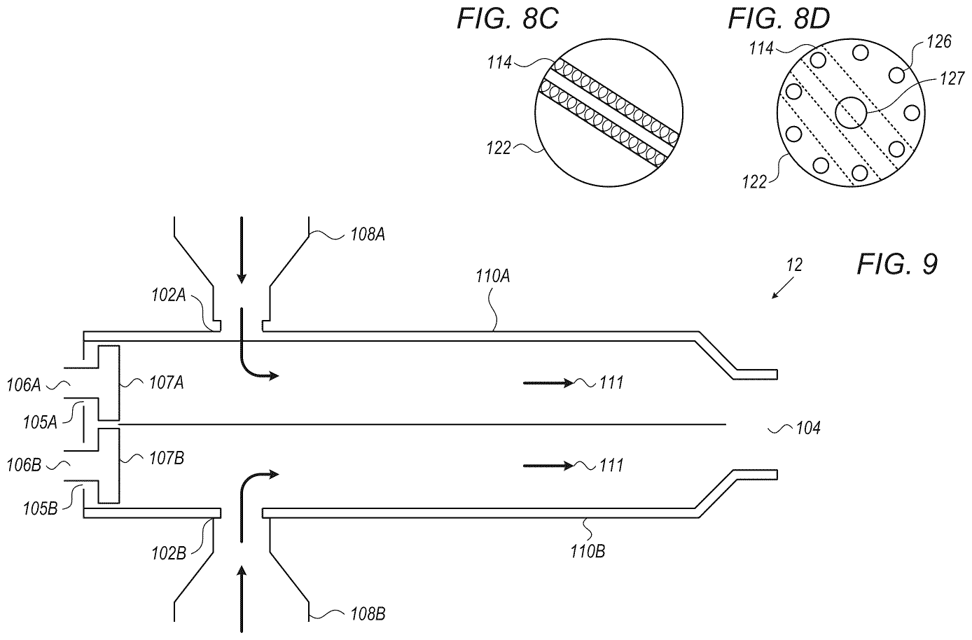

Reference is now made to FIGS. 8A, 8B, 8C and 8D which depict a variable flow recyclable material extrusion system, according to some embodiments of the invention. As shown, FIG. 8A depicts a variable flow recyclable material extrusion system 10, wherein heating element/s 114 may be configured to pass through the containing volume 110 such that the recyclable material is in contact with said heating element/s 114 and passing through it on its way along line 111 towards outlet 104.

FIGS. 8B, 8C and 8D depicts variable modifications of cover 126 along with containing volume 110. According to some embodiments, cover 122 may be configured to be fitted to outlet 104 and further comprising at least one aperture 126 designated to extract the recyclable material or any other composite material that has been created within the containing volume 110. According to some embodiments, heating element 114 may be configured to be integrated within/on cover 122, and when integrated within, the recyclable material may be in contact and flow along said heating elements 114 on its way out of aperture 104 as disclosed above.

For example, multiple apertures 126 may be arranged along the perimeter of cover 122, etc. According to same embodiments central aperture 127 may be positioned in the central area of cover 122 along said heating elements 114 and be designated to provide the recyclable material or composite material a way out after passing through aperture 104 as disclosed above. According to some embodiments, heating clement/s 114 may be positioned in any angle along/across cover 122.

Reference is now made to FIG. 9 which depicts a variable flow recyclable material extrusion system 12, according to some embodiments of the invention. As shown, extrusion system 12 may essentially comprise of an annular, substantially cylindrical containing volumes 110A & 110B, each substantially enclosing a volume. According to some embodiments, each containing volumes 110A & 110B may be configured with at least four apertures, for example, inlet apertures 108A & 108B may be configured as a hopper designated to supply materials to be processed and outlet aperture 104 may be configured as an outlet designated to provide an output to said processed materials. According to some embodiments, the recyclable material is designated to be processed into other materials having different properties.

According to some embodiments, each container 110A and 110B may be configured with an additional apertures 105A and 105B through which a sliding elements 106A and 106B having a positive displacement means 107A and 107B may be installed. For example, sliding elements 106A & 106B may be a piston shaped shaft designated to compress the material within containing volume 110A & 110B. According to some embodiments, positive displacement means in any shape or form that may produce the same or similar effect according to the present invention may be utilized.

According to some embodiments, a typical method of extrusion operation would entail the inputting of recyclable materials into both hoppers 108A and 108B which is to be coupled with apertures 102A & 102B. According to some embodiments, compressing means may be installed above of within hoppers 108A and 108B (not shown) and configured force materials into the containing volumes 110A & 110B and through apertures 102A & 102B to be further advanced by the sliding elements 106A & 106B towards containing volume's outlet aperture 104. According to some embodiments, the variable flow extrusion system 12 is designated to apply certain pressures to the recyclable materials which, in turn, are designated to progress along flow line 111.

According to some embodiments, variable flow extrusion system 12 may be capable of continuous operation by providing doubled capabilities, for example, when one displacement means 107A or 107B is advancing towards aperture 104 along line flow line 111, or alternatively, has reached the end of its course, the second displacement means 107A or 107B may start advancing and displacing the recyclable material, hence, a continuous and uninterrupted operation is enabled. According to some embodiments, variable flow extrusion system 12 may comprise multiple containing volumes 110A & 110B, each equipped with the components specified above so a continues operation is enabled in a larger scale.

Although the present invention has been described with reference to specific embodiments, this description is not meant to be construed in a limited sense. Various modifications of the disclosed embodiments, as well as alternative embodiments of the invention will become apparent to persons skilled in the art upon reference to the description of the invention. It is, therefore, contemplated that the appended claims will cover such modifications that fall within the scope of the invention.

1. A variable flow recyclable material extrusion system, comprising:
(i) at least one containing volume of substantially a barrel shape having an outlet and an inlet and designated to contain a recyclable material that comprises various substances having at least two thermodynamic phases and capable of a multiphase flow,
(ii) at least one sliding element configured to move within said containing volume and further configured to increase the pressure of the recyclable material and create a movement thereof toward the outlet of said containing volume,
(iii) at least one physical structure located along the inner perimeter of the containing volume, and
(iv) a power source,
wherein the recyclable material is designated to flow within the containing volume along a flow line in accordance with the multiphase flow of the substances,
wherein the at least one physical structure is designated to affect the multiphase flow of a substance/s by creating a movement thereof at different thermodynamic phases, and
wherein said movement is designated to obtain predetermined physical properties of the extruded recyclable materials.

2. (canceled)

3. The system of claim 1, further comprising at least one heating element configured to affect the conversation of the recyclable material.

4. The system of claim 3, wherein the heating element is located outside the at least one containing volume and designated to heat the recyclable material without direct contact with it.

5. The system of claim 3, wherein the heating element is located inside the containing volume and designated to heat the recyclable material using a direct contact with it.

6. The system of claim 3, wherein the at least one heating element is located at different angles/orientations relative to the flow line in order to have a different effect on the different thermodynamic phases in the recyclable material.

7. The system of claim 1, wherein the at least one sliding element is at least two sliding elements are configured to move within one containing volume and further configured create a spiral movement.

8. The system of claim 3, wherein the sliding element comprises designated notch/es configured to accommodate the heating element/s and thus enabling the sliding element to advance further within the containing volume towards the outlet.

9. The system of claim 3, wherein the sliding element comprises a designated inclined front surface configured to accommodate correspondingly inclined heating element/s and thus enabling the sliding element to advance further within the containing volume towards the outlet.

10. The system of claim 1, wherein the outlet is configured to be fitted with a cover having at least one aperture.

11. (canceled)

12. The system of claim 1, further comprising at least one recess embedded in the inner perimeter of the containing volume and further comprising at least one physical structure configured to affect the multiphase flow of a substance/s by creating a movement thereof in the recyclable material's different thermodynamic phases.

13-15. (canceled)

16. The system of claim 12, wherein the at least one recces further comprises at least one heating element.

17. The system of claim 1, wherein the at least one physical structure is configured to create turbulences designated to have a greater effect on the substance/s having a slower thermodynamic phase in comparison with substances having a faster thermodynamic phase.

18. (canceled)

19. The system of claim 1, wherein the composite material comprises various substances such as organic/nonorganic substances, aggregates, cellulose, polymers, etc.

20. The system of claim 1, wherein the recyclable material is a waste material processed to particles.

21-23. (canceled)

24. The system of claim 1, wherein the at least one physical structure is a protrusion configured to affect the flow of at least one substance.

25-27. (canceled)

28. The system of claim 1, wherein the physical structure is at least one aperture/slit.

29. (canceled)

30. The system of claim 1, wherein the at least one physical structure is at least two physical structures are designated to be located on a same perpendicular cross-section plane along the containing volume.

31. The system of claim 1, wherein the at least one physical structure is at least two pairs of physical structures are designated to be located on different perpendicular cross-section planes along the containing volume.

32. The system of claim 1, wherein the recyclable material comprises polymeric and non-polymeric substances, the latter being designated to melt and encapsulate the former.

33. (canceled)

34. A method for using a variable flow recyclable material extrusion system, comprising the steps of:
(i) feeding a recyclable material to a containing volume of substantially a barrel shape having an outlet and an inlet,
(ii) translating the recyclable material using at least one sliding element powered by a power source and configured to move within the containing volume toward its outlet,
wherein the recyclable material comprises various substances having at least two thermodynamic phases and capable of a multiphase flow,
wherein the recyclable material is designated to flow within the containing volume along a flow line in accordance with the multiphase flow of the substances,
wherein at least one physical structure is designated to be located on the inner perimeter of the containing volume and affect the multiphase flow of a substance/s by creating a movement thereof at different thermodynamic phases, and
wherein said movement is designated to obtain predetermined physical properties of the extruded recyclable materials.
